(19) United States
(12) Patent Application Publication
(10) Pub. No.: US 2016/0371677 A1
(43) Pub. Date: Dec. 22, 2016

(54) ELECTRONIC DEVICE AND OUTPUT DEVICE SHORT RANGE COMMUNICATION PAIRING SYSTEM AND METHOD

(71) Applicant: Allen Hyun-woo Kim, Peoria, IL (US)

(72) Inventor: Allen Hyun-woo Kim, Peoria, IL (US)

(21) Appl. No.: 14/744,228

(22) Filed: Jun. 19, 2015

(51) Int. Cl. G06Q 20/32; G06Q 20/10; H04W 4/00; H04B 5/00

(52) U.S. Cl. CPC G06Q 20/3278; H04B 5/0062; G06Q 20/10; H04W 4/008

(57) ABSTRACT

A system to pair a mobile electronic device to an output device to output content from content data stored on a memory component, the memory component located in the mobile electronic device or locatable by the mobile electronic device includes a pairing server configured to send the content data to the output device in response to an output request by the mobile electronic device, a short range communication tag associated with the output device, and comprising identifying data associated with the output device, and a short range communication module communicatively and removeably coupled to, or comprising an element of, the mobile electronic device; and configured to receive the identifying data from the short range communication tag.

### BACKGROUND OF THE INVENTION

The present invention generally relates to systems and methods to pair a mobile electronic device to an output device for outputting content data, and more particularly to pairing the mobile electronic device and output device with a short range communication module and short range communication tag.

Mobile electronic devices, such as smartphones, electronic tablets, and laptop computers are now ubiquitous in society. However, it is sometimes difficult to find and easily utilize an output device to output content (such as printed two dimensional documents, multi-media presentations, video and/or audio compositions, and three dimensional objects) at a desired location. Some output devices, such as two dimensional printers, three dimensional printers, and displays allow a mobile electronic device to communicate output content through signing onto a local area network, or through a memory stick device to transfer content. However, signing onto a network can be time consuming and/or require obtaining passwords and/or setting up an account. Many mobile electronic devices do not have the ports necessary for memory stick content transfer. Security of content being outputted can be compromised if the communication link between the mobile electronic device and output device is not secure. Traditional short-range communication tags such as bar codes may not have the capacity to store enough data for adequate encryption of information for secure data transfers. Tags which are now read by mobile telephone scanners may direct the user to information on a website, but may be incapable of storing the information in the tag itself, and/or may be incapable of reliably and securely storing the information in the tag itself.

As can be seen, there may be an ongoing need for systems and methods to pair mobile electronic devices to output devices in a quick, secure, and efficient manner.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

In one aspect of the present invention, a system to pair a mobile electronic device to an output device to output content from content data stored on a memory component, the memory component located in the mobile electronic device or locatable by the mobile electronic device; includes a pairing server, a short range communication tag associated with the output device, a short range communication module, and the mobile electronic device. The pairing server includes an output device information and driver database including communication, driver, and identifying data associated with the output device; and a pairing module configured to send the content data to the output device in response to an output request by the mobile electronic device, and to send the content data to the output device utilizing the communication, driver, and identifying data associated with the output device. The output device includes an output device communication module configured to send and receive data to and from the pairing server. The short range communication tag includes the identifying data associated with the output device. The short range communication module is communicatively and removeably coupled to, or comprises an element of, the mobile electronic device; and is configured to receive the identifying data from the short range communication tag. The mobile electronic device includes a communication module configured to send and receive data to and from the pairing server; and a pairing application module configured to send an output request to the pairing server, the output request including the identifying data, and at least one of the content data or a location of the content data.

In another aspect of the present invention, a computer program product includes a computer readable storage medium, and computer usable code stored on the computer readable storage medium. If executed by a processor, the computer readable code causes a computer to receive identifying data for an output device from a near field communication tag associated with the output device, the identifying data received through a near field communication reader/writer module; receive from a pairing server functional and pricing information associated with the identifying data; display on a user interface functional and pricing options to a user; receive a user input indicative of an output request, the output request including desired content output from the output device; and send the output request to the pairing server, the pairing server configured to send the content data to the output device in response to the output request.

In yet another aspect of the present invention, a method of pairing a mobile electronic device with an output device through a pairing server, includes wirelessly transmitting encrypted identifying data associated with the output device from a short range communication tag to the mobile electronic device through a short range communication link; and transmitting through at least one of a communication link and a network, a content output request from the mobile electronic device to the pairing server, the content output request indicative of the identifying data and desired content to be outputted by the output device. The method further includes transmitting through at least one of communication links and a network, the desired content from the pairing server to the output device; and outputting the desired content with the output device.

These and other features, aspects and advantages of the present invention will become better understood with reference to the following drawings, description and claims.

### BRIEF DESCRIPTION OF THE DRAWINGS

FIG. 1 is a block diagram of an exemplary system to pair a mobile electronic device to an output device for outputting content.

FIG. 2 is a block diagram of an exemplary system for a user to set-up a customer account on a pairing server.

FIG. 3 is a block diagram of an exemplary system for a device owner and/or provider to set up a device provider account on a pairing server and provide information on an output device to the pairing server.

FIG. 4 is a block diagram of an exemplary system for a user to download a pairing application and register a mobile electronic device with a customer account on a pairing server.

FIG. 5 is a flowchart of an exemplary method for a user to set-up a customer account on a pairing server.

FIG. 6 is a flowchart of an exemplary method for a device provider to set up a device provider account on a pairing server and provide information on an output device to the pairing server.

FIG. 7 is a flowchart of an exemplary method for a user to download a pairing application and register a mobile electronic device with a customer account on a pairing server.

FIG. 8A is a flowchart of a first portion of an exemplary method for pairing a mobile electronic device with an output device for outputting content.

FIG. 8B is a flowchart of a second portion of the exemplary method for pairing a mobile electronic device with an output device for outputting content of FIG. 8A.

FIG. 8C is a flowchart of a third portion of the exemplary method for pairing a mobile electronic device with an output device for outputting content of FIGS. 8A and 8B.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above, or may only address one of the problems discussed above. Further, one or more of the problems discussed above may not be fully addressed by any of the features described below.

As will be appreciated by one skilled in the art, aspects of the present invention may be embodied as a system, method or computer program product. The whole or portions of the computer program product may be loaded on one or more memory components of a mobile electronic device, output device, pairing server and/or combination thereof. When loaded onto the one or more memory components, the computer program product may be executable by one or more processors to cause the mobile electronic device, output device, pairing server and/or combination thereof to perform exemplary methods described below. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage medium(s) having computer readable program code embodied thereon.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The computer program code may execute entirely on at least one of the mobile electronic device, output device, and pairing server, and/or combination thereof; partly on at least one of the mobile electronic device, output device, and pairing server, and/or combination thereof; as a stand-alone software package; partly on the at least one of the mobile electronic device, output device, pairing server and/or combination thereof and partly on a another remote computer device or server; or entirely on one or more remote computer devices or servers. When the program code is executed partly or entirely on remote computer devices and/or servers, the remote computer devices and/or servers may be connected to the one or more mobile electronic devices, output devices, and/or pairing servers through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, mobile electronic device, output devices, pairing server, or other programmable data processing apparatus to produce a machine, such that the instructions, which execute via the processor of the computer, mobile electronic device, output device, pairing server, or other programmable data processing apparatus, create means for implementing the functions/acts specified in the flowchart and/or block diagram block or blocks.

These computer program instructions may also be stored in a computer readable medium that can direct a computer, mobile electronic device, output device, pairing server, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, mobile electronic device, output device, pairing server, other programmable data processing apparatus, and/or other devices. The computer program instructions thus loaded may cause a series of operational steps to be performed on the computer, mobile electronic device, output device, pairing server, other programmable apparatus, and/or other devices. When the operational steps are performed, they may produce a computer implemented process such that the instructions which execute on the computer, mobile electronic device, output device, pairing server, or other programmable apparatus provide processes for implementing the functions/acts specified in the flowchart and/or block diagram block or blocks.

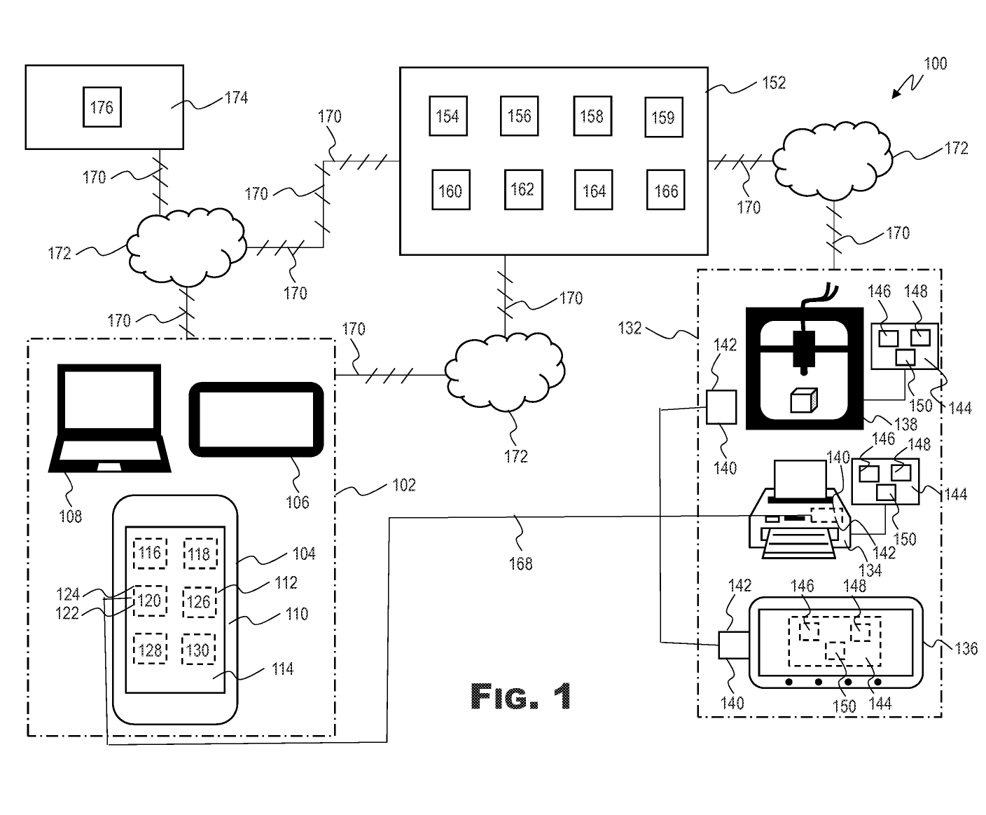

Referring now to FIG. 1, a block diagram of an exemplary system 100 to pair a mobile electronic device 102 to an output device 132 for outputting content, is illustrated. The content may be outputted from content data stored on a memory component 118, 176. The memory component 118, 176 may be located in the mobile electronic device 102 or be locatable by the mobile electronic device 102. The system 100 may include the mobile electronic device 102, a pairing server 152, the output device 132, a short range communication tag 140, and a short range communication module 120. The pairing server 152 may include an output device information and driver database 160 and a pairing module 164. The output device information and driver database 160 may include communication, driver, and identifying data associated with the output device 132. The pairing module 164 may be configured to send the content data to the output device 132 in response to an output request by the mobile electronic device 102, and to send the content data to the output device 132 utilizing the communication, driver, and identifying data associated with the output device 132. The output device 132 may include an output device communication and status module 150 configured to send and receive data to and from the pairing server 152. The short range communication tag 140 may be associated with the output device 132, and include the identifying data associated with the output device 132. The short range communication module 120 may be communicatively and removeably coupled to, or comprising an element of, the mobile electronic device 102, and be configured to receive the identifying data from the short range communication tag 140. The mobile electronic device 102 may include a communication module 128 and a pairing application module 126. The communication module 128 may be configured to send and receive data to and from the pairing server 152. The pairing application module 126 may be configured to send an output request to the pairing server 152, the output request including the identifying data, and at least one of the content data or a location of the content data.

The mobile electronic device 102 may include any computing device which may typically be small enough and light enough to be carried with or worn by a person from place to place. Non-limiting examples of mobile electronic device 102 include mobile phones (including smartphones 104), electronic tablets 106, laptop computers 108, watches, small electronic devices worn as a necklace, bracelet, or other device configured to be attached to a human, and small electronic devices carried or attached in clothing (such as a pen or keychain). The mobile electronic device 102 may include a housing 110 and a user interface 112. The user interface 112 may include a display for displaying information to a user, and input devices for allowing the user to make enter desired commands or information. In the illustrated embodiment, the display and input devices are combined in an interactive touchscreen 114. However, the display and user input devices may take many forms. The display may, for example include a liquid crystal display (LCD), a light emitting diode (LED) display, or the like. In addition to the touchscreen, non-limiting examples of the user input devices include keyboards, voice activated input devices, buttons, dials, switches, breath activated devices and the like for physically handicapped users, and/or other devices that allow a user to input desired commands and/or information.

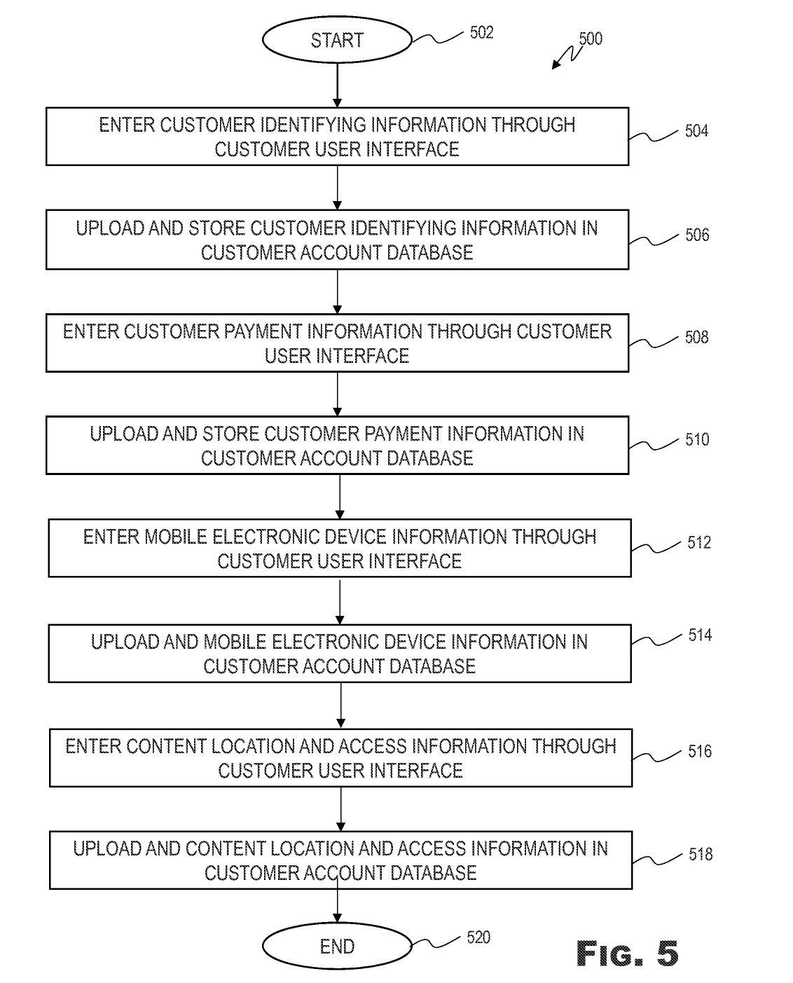

The mobile electronic device 102 may include a processor 116, and a memory component 118. The processor 116 may include microprocessors or other processors as known in the art and capable of executing instructions, as described below and in relation to FIGS. 5, 7, and 8A-8C. In some embodiments the processor 116 may include multiple processors which may be operably connected. Such instructions may be read into or incorporated into a computer readable medium, such as the memory component 118, or provided external to processor 116. The instructions may include multiple lines or divisions of code. The lines or divisions of code may not be in consecutive order, and may not be located in the same section of code. In alternative embodiments, hard-wired circuitry may be used in place of or in combination with software instructions as described above, below, or in relation to the drawings. The memory component 118 may include computer readable storage medium as described above. In some embodiments the memory component 118 may include multiple memory components.

The mobile electronic device 102 may include an operating system, and may run various types of application software, sometimes referred to as apps. The mobile electronic device 102 may also include features like a camera, and a media player feature for video and/or music files. The mobile electronic device 102 may also include a power supply (not shown) which may include batteries or other power storage devices, and/or a port to connect to an AC or DC power supply.

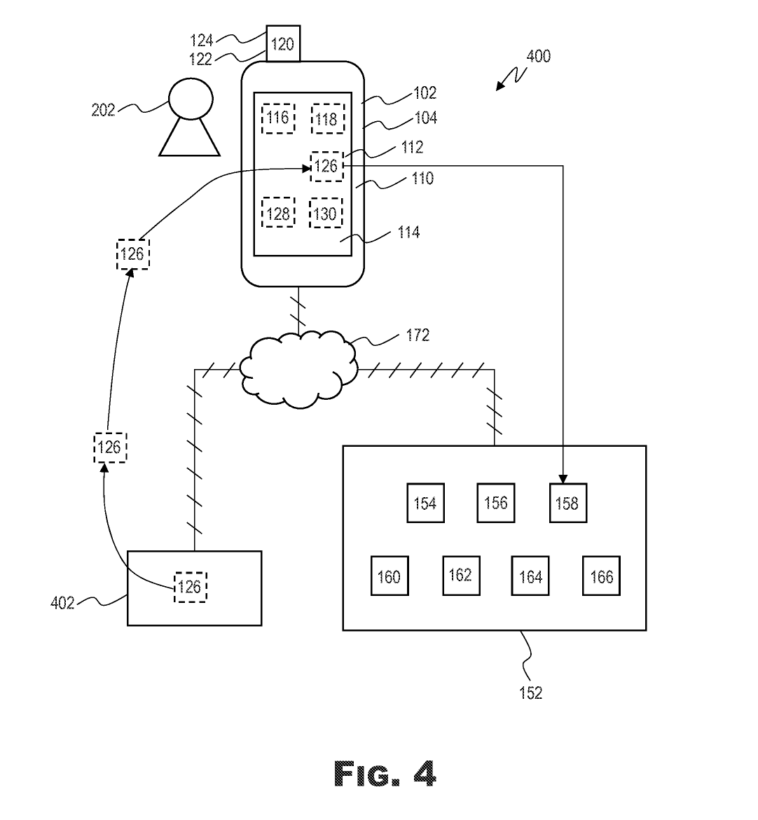

As shown in the illustrated embodiment, the short range communication module 120 may be an integral part of the mobile electronic device 102. FIG. 4 illustrates an alternative embodiment in which the short range communication module 120 may be a separate component which is communicatively and removeably attached to the mobile electronic device 102. The short range communication module 120 may be configured to communicate with and/or receive information, including identifying data, from the short range communication tag 140, when the short range communication module 120 is touched to or put within a predetermined distance from the short range communication tag 140. The predetermined distance may be, for example, in the range of five to fifteen centimeters, or may be ten centimeters. The identifying data may include encryption information.

The short range communication module 120 may comprise a near field communication (NFC) module 122. An NFC module 122 may be a module which may establish radio communication with another NFC device by touching the devices together or bringing them into proximity to the predetermined distance or less. The NFC module 122 may comprise a NFC reader/writer module 124. The NFC reader/writer module 124 may include a device configured to read information stored on an NFC tag, which may, for example, be embedded in a label or smart poster. An NFC tag may be capable of storing enough data such that identifying data is adequately encrypted for secure transfer. For example, the NFC tag may store between 96 and 4,096 bytes of memory. The NFC tag may be read-only, but may be rewritable. Traditional tags such as bar codes may only store a small amount of data, may be unable to store enough data such that adequate encryption for secure transfer of identifying data is possible, and may not be rewritable. NFC tags may be custom-encoded by their manufacturers or use the industry specifications provided by the NFC Forum, an association with more than 160 members founded in 2004. The short range communication tag 140 may include a NFC tag 142.

The NFC reader/writer module 124 may include a loop, or other type, first antennae (not shown). The NFC tag 142 may include a loop, or other type second antennae (not shown). The NFC reader/writer module 124 may employ electromagnetic induction between the first antennae and the second antennae to exchange information, and may, in one embodiment, operate within the globally available unlicensed radio frequency ISM band of 13.56 MHz on ISO/IEC 18000-3 air interface and at rates ranging from 106 kbit/s to 424 kbit/s. Although the ISM band of 13.56 MHz is now globally available and unlicensed, it is contemplated that this may change in the future. It is also contemplated that there may be frequency bands regionally available other than this band. Other embodiments of the NFC reader/writer module and NFC tag may operate at another frequency that is globally or regionally available and unlicensed.

In one embodiment, the NFC reader/writer module 124 may provide a carrier field, and the NFC tag 142 may answer by modulating the existing carrier field. In this embodiment, the NFC tag 142 may draw operating power from the NFC reader/writer module 124 provided electromagnetic field. In an alternative embodiment, the NFC tag 142 may include a NFC device with its' own power supply (not shown). In this embodiment the NFC reader/writer module 124 and the NFC tag 142 may communicate by alternately generating their own fields. The NFC reader/writer module 124 and the NFC tag 142 may deactivate their fields while waiting for data.

The NFC reader/writer module 124 and NFC tag 142 may operate within NFC standards covering communications protocols and data exchange formats The NFC standards may be based on existing radio-frequency identification (RFID) standards including ISO/IEC 14443 and FeliCa. The NFC standards may include ISO/IEC 18092 and those defined by the NFC Forum. In some embodiments, The NFC reader/writer module 124 and NFC tag 142 may operate within standards defined by the Groupe Speciale Mobile Association (GSMA). It is contemplated that other communication protocols and data exchange formats may be used in other embodiments.

The mobile electronic device 102 may include a pairing application module 126. The pairing module 126 may be configured to send an output request to the pairing server 152 to output desired content to the output device 132. The output request may include the identifying data, and at least one of the content data or a location of the content data. The pairing module 126 may include executable computer program code, and data stored on computer readable storage medium in the memory component 118, which when executed by the processor 116 may implement instructions of the methods shown and described in relation to FIGS. 5, 7, and 8A-8C. Although illustrated as a single component, the lines or divisions of the executable computer program code need not be in consecutive order, and may not be located in the same section of code, or in the case of multiple processors, the same processor. The pairing module 126 may pair the mobile electronic device 102 with the output device 132 through the pairing server 152, such that a user may output content from the output device 132 through an input to the user interface 112 without a direct communication link 170.

The mobile electronic device 102 may include a communication module 128 to allow the mobile electronic device 102 to send and receive data from other electronic and computer devices through communication links 170 and communication networks 172. The communication module 128 may include one or more receivers and transmitters, executable computer program code and data stored on computer readable storage medium in the memory component 118, and other interfaces for communication as known in the art. The communication module 128 may allow the mobile electronic device 102 to communicate using multiple types of communication methods, links, and protocols. Non-limiting examples of networks the communication module 128 may support include wireless networks, data or packet networks, publicly switched telephone networks (PSTN), cellular networks, wide area networks (WAN), and adjacent local area networks (LAN).

The mobile electronic device 102 may include a content creator module 130 which may be configured to create content which may be outputted on the output device 132. The content creator module 130 may include executable computer program code and data stored on computer readable storage medium in the memory component 118. The content creator module 130 may comprise all the elements to create the content, or the content creator module 130 may comprise executable program code which causes the interaction of the mobile electronic device 102 with a module (for example a cloud program) on a separate server (not shown) to create the content. The content creator module 130 may, for example, comprise a document, spreadsheet, or presentation creation program. Other non-limiting examples of programs or modules which may be contained in the content creator module 130 include a camera, video camera, video and/or audio media creating software, audio recording software, and/or 3D model creation software. The content creation module 130 may store the content created on the memory component 118 or on a separate content server 176.

The mobile electronic device 102 may be communicatively linked to the pairing server 152 through communicative link 170 and/or networks 172. The mobile electronic device 102 may be communicatively linked to the content server 176 through communicative link 170 and/or networks 172. The mobile electronic device 102 may be communicatively linked to the short-range communication tag 140 through short-range communicative link 168 when the mobile electronic device 102 is within the predetermined distance from the short-range communication tag 140.

The output device 132 may comprise any device configured to receive content data and output the content associated with the data. Content may include any useful media. Non-limiting examples of content may include printed documents, a facsimile transmission, a three dimensional object, and an image or collection of images on a display or screen. Three embodiments of the output device 132 are illustrated—a combination printer/facsimile/copier 134, a large display monitor 136, and a 3D printer 138. Other non-limiting examples of the output device 132 not shown include television sets; projectors; and industrial computer controlled machines such as welders, cutters, and machining machines.

The short-range communication tag 140 associated with the output device 132, and containing the identifying data for the output device 132, may take several forms. Three embodiments are illustrated. The printer/facsimile/copier 134 is illustrated with the short-range communication tag 140 being integral. The large display monitor 136 is shown with the short-range communication tag 140 being a separate unit attached to the monitor 136. The 3D printer is shown with the short-range communication tag 140 being a separate unit located close to, but unattached to, the 3D printer. The identifying data may be encrypted such communication through that the communication link 168 may be secure.

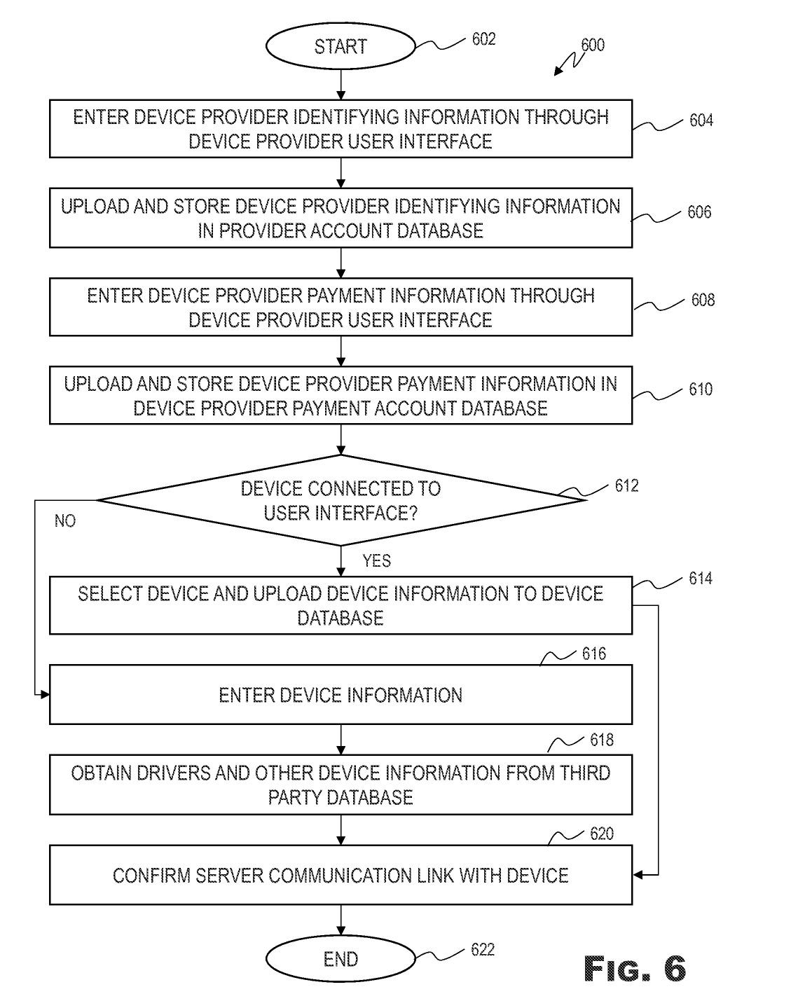

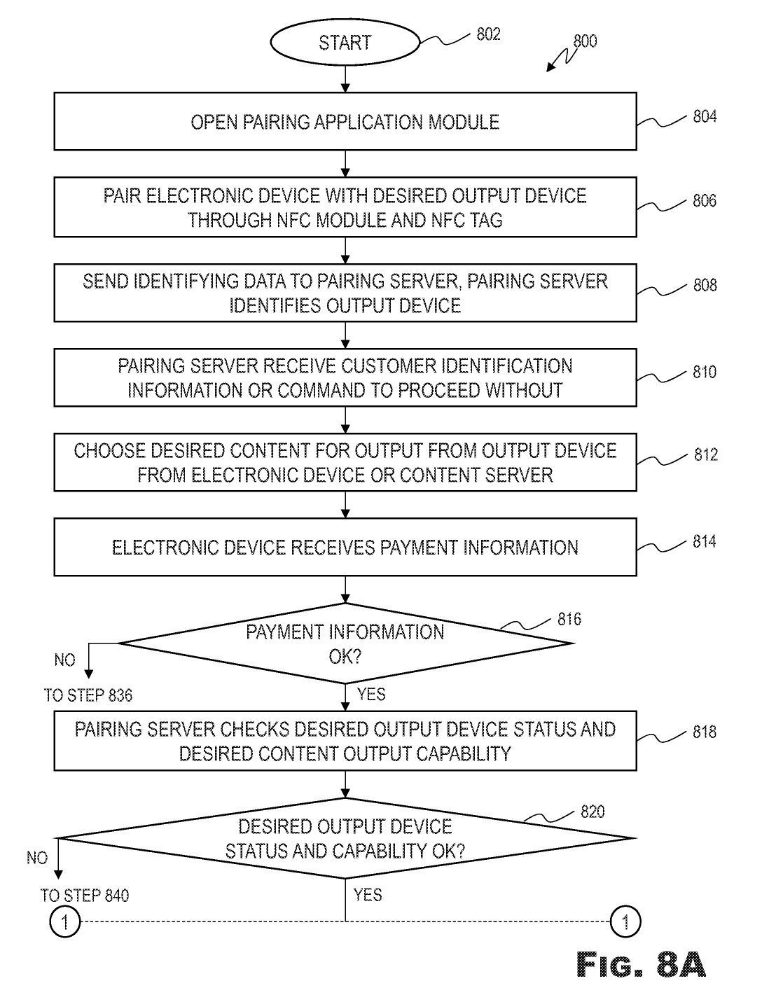

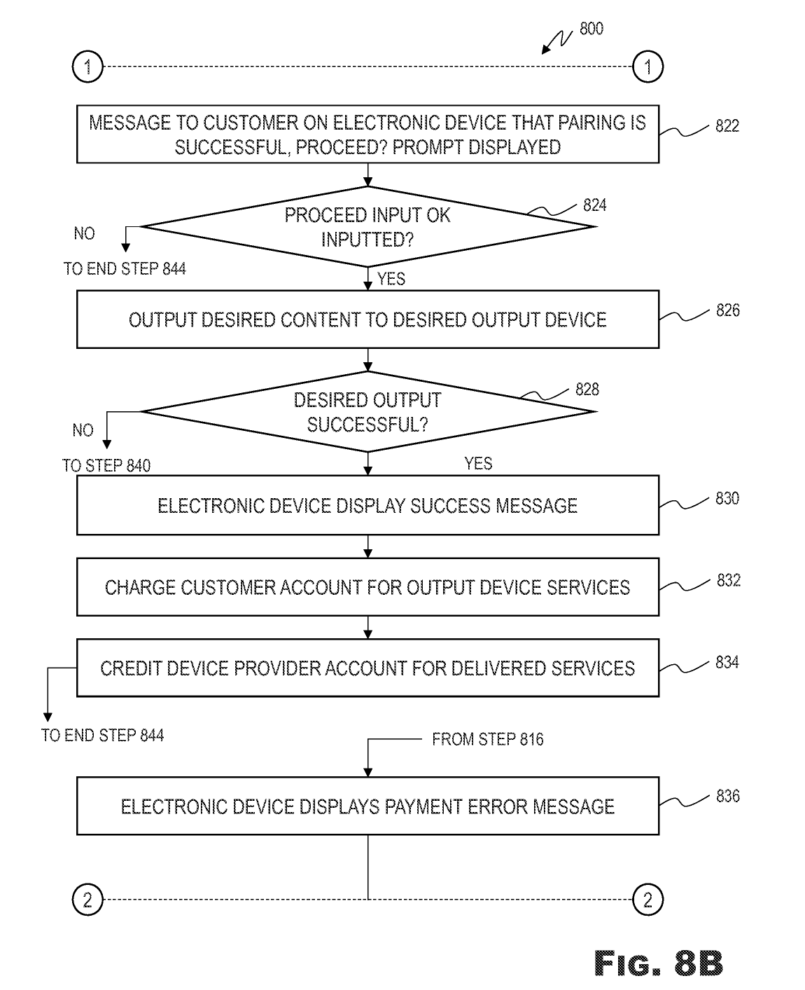

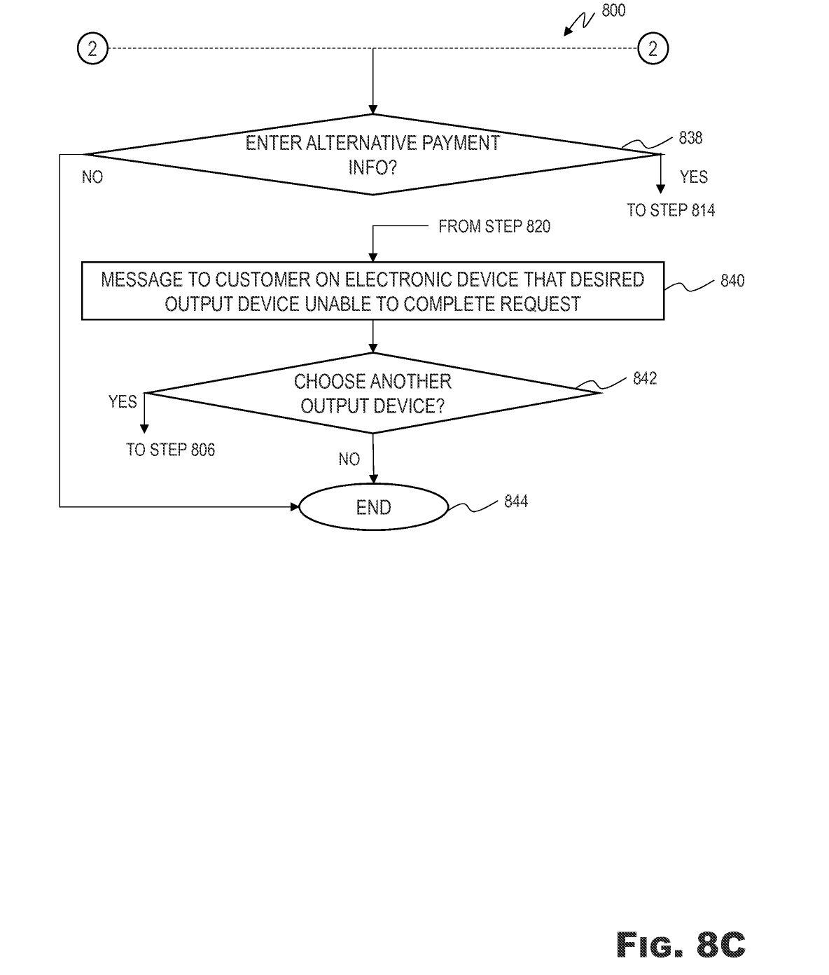

The output device 132 may include a controller 144 configured to control the operation of the output device 132. The controller 144 may include a processor 146, a memory device 148, and a communication/status module 150. The processor 146 may include microprocessors or other processors as known in the art and capable of executing instructions, as described below and in relation to FIGS. 6, and 8A-8C. In some embodiments the processor 146 may include multiple processors which may be operably connected. Such instructions may be read into or incorporated into a computer readable medium, such as the memory component 148, or provided external to processor 146. The instructions may include multiple lines or divisions multiple lines or divisions of code. The lines or divisions of code may not be in consecutive order, and may not be located in the same section of code. In alternative embodiments, hard-wired circuitry may be used in place of or in combination with software instructions as described above, below, or in relation to the drawings. The memory component 148 may include computer readable storage medium as described above. In some embodiments the memory component 148 may include multiple memory components.

The communications/status module 150 may be configured to allow the output device 132 to send and receive data from other electronic and computer devices through communication links 170 and communication networks 172; and to provide status information on the functional capabilities of the output device 132 at any given time. The communication/status module 150 may include one or more receivers and transmitters, executable computer program code and data stored on computer readable storage medium in the memory component 148, and other interfaces for communication as known in the art. The communication/status module 150 may allow the output device 132 to communicate using multiple types of communication methods, links, and protocols. Non-limiting examples of networks the communication/status module 150 may support include wireless networks, data or packet networks, publicly switched telephone networks (PSTN), cellular networks, wide area networks (WAN), and adjacent local area networks (LAN). The controller 144 may be configured to run status checks on the functional capability of the output device as is known in the art, and to store functional data in the memory component 148. Status information may be compiled from the functional data. Status information may include, but is not limited to, whether the supplies needed to output content are available, whether the output device 132 is functioning satisfactorily, whether the output device 132 is currently being used, and/or times in which the output device 132 is scheduled to be used. The output device 132 may be communicatively connected to the pairing server 152 through communicative links 170 and networks 172.

In some embodiments, the output device 132 may not include electronics with the technical capability to fulfill the required functions of the controller 144. In these embodiments, the controller 144 may include a module which is communicatively connected to the output device 132, with additional electronics, processors, and memory components such that the output device is technically able to fulfill the controller 144 requirements.

The pairing server 152 may include any computer or operatively connected group of computers running a software application capable of accepting requests from a client and giving responses accordingly to implement methods described in this description and illustrated in the drawings. In some embodiments, operations other than those described herein may also run on the computer, and executable program code and data other than that described herein may also be stored in a within the computer. The pairing server 152 may include a processor 154 and a memory component 156. The processor 154 may include microprocessors or other processors as known in the art and capable of executing instructions, as described below and in relation to FIGS. 5-7, and 8A-8C. In some embodiments the processor 154 may include multiple processors which may be operably connected. Such instructions may be read into or incorporated into a computer readable medium, such as the memory component 156, or provided external to processor 154. The instructions may include multiple lines or divisions multiple lines or divisions of code. The lines or divisions of code may not be in consecutive order, and may not be located in the same section of code. In alternative embodiments, hard-wired circuitry may be used in place of or in combination with software instructions as described above, below, or in relation to the drawings. The memory component 156 may include computer readable storage medium as described above. In some embodiments the memory component 156 may include multiple memory components.

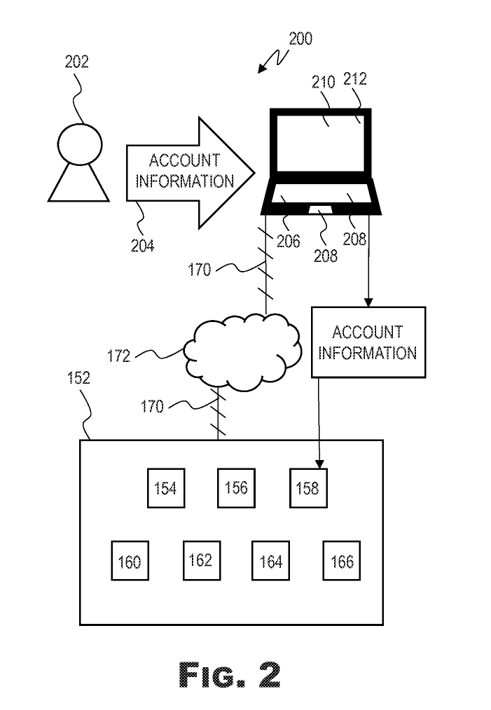

The pairing server 152 may include a customer account database 158. The customer account database 158 may include customer data associated with information on customers who have signed up for system 100 customer accounts, payment data associated with those customers, data associating mobile electronic devices 102 with those customers, and data associating content locations such content servers 174 with those customers. The payment data may, for example, include bank account, credit card, and/or other payment information on ways the customer desires to pay for outputting content on an output device 132. The data associating content locations such content servers 174 with those customers may include, for example, cloud storage locations and user names, passwords, or other information needed to access content. The customer data may be stored on memory component 156. The storage of the customer data may be done in accordance with the method described in relation to FIGS. 2 and 5.

The pairing server 152 may include a content conversion module 159. The content conversion module 159 may convert content data from the mobile electronic device 102 (or from a content location identified by the mobile electronic device 102) to a data form that the output device 132 may generate the output of content from. The content conversion module 159 may include executable computer program code, and data stored on computer readable storage medium in the memory component 156, which when executed by the processor 154 may implement instructions of the methods shown and described in relation to FIGS. 5-7, and 8A-8C. Although illustrated as a single component, the lines or divisions of the executable computer program code need not be in consecutive order, and may not be located in the same section of code, or in the case of multiple processors, the same processor.

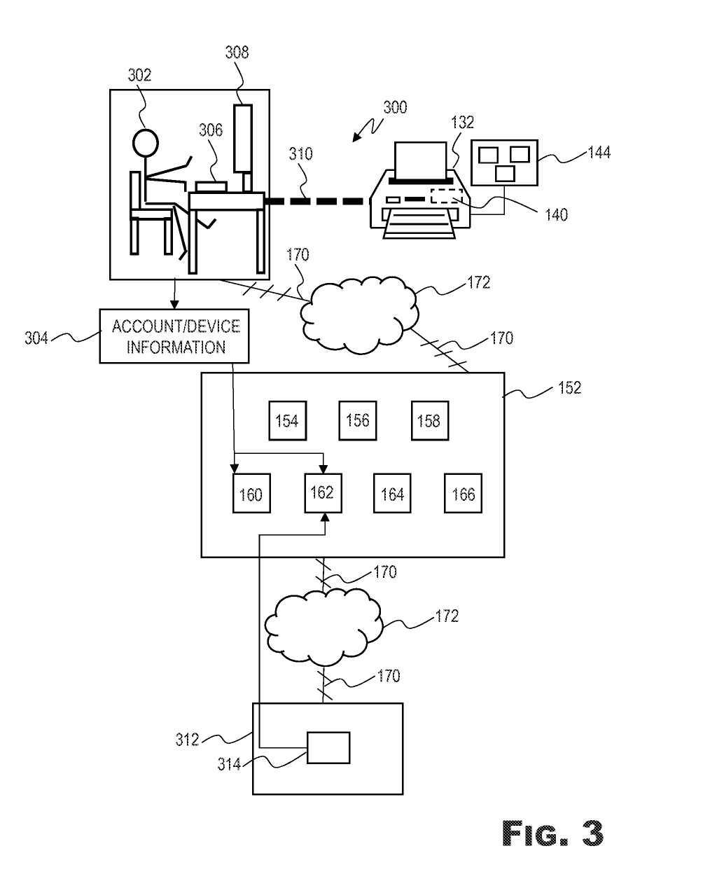

The pairing server 152 may include a device provider database 160. The device provider database 160 may include device provider data associated with information on device providers who have signed up for system 100 device provider accounts to allow one or more of their output devices 132 to receive content from a customer's mobile electronic device 102 and output the content. The device provider database 160 may include payment data associated with those device providers, and data associating specific output devices 132 with those device providers. The payment data may include, for example, information a bank account or other account to which payment for outputting content on an output device 132 associated with the device provider may be paid. The device provider data may be stored on memory component 156. The storage of the device provider data may be done in accordance with the method described in relation to FIGS. 3 and 6.

The pairing server 152 may include a device information and driver database 162. The device information and driver database 162 may include device drivers, or the location of device drivers available for user for all output devices 132 associated with the system. The device information and driver database 162 may include device information data for each output device 132 in the system. The device information data may include, but is not limited to, the identifying data included on the short-range communication tag, functionality of the output device 132 (i.e., what content can it output), at what times the output device 132 is available, communication information allowing the pairing server to communicate with the output device 132 (such as, for example, an IP address, or MAC address of the output device 132) and pricing information on any output of content from the output device 132. The device data, device drivers, and/or location of available device drivers may be stored on memory component 156. The storage of the device data, device drivers, and/or location of available device drivers may be done in accordance with the method described in relation to FIGS. 3 and 6.

The pairing server 152 may include a pairing module 164. The pairing module 164 may be configured to receive an output request from the mobile electronic device 102 and send content data associated with the desired content to the output device 132 in response to the output request. The pairing module 164 may be configured to send to the mobile electronic device information on the output device 132 associated with the identifying data, such as, for example, functionality information, availability information, and pricing information. The pairing module 164 may be configured to receive status information from the output device 132, and to communicate this status information to the mobile electronic device 102. The pairing module 164 may include executable computer program code, and data stored on computer readable storage medium in the memory component 156, which when executed by the processor 154 may implement instructions of the methods shown and described in relation to FIGS. 5-7, and 8A-8C. Although illustrated as a single component, the lines or divisions of the executable computer program code need not be in consecutive order, and may not be located in the same section of code, or in the case of multiple processors, the same processor. The pairing module 164 may pair the mobile electronic device 102 with the output device 132 such that a user may output content from the output device 132 through an input to the user interface 112 of the mobile electronic device 102.

The pairing server 152 may include a payment module 166. The payment module 166 may be configured to facilitate a payment by the customer making a content output request with the mobile electronic device 102 to the device provider associated with the output device 132 outputting the content, in response to the output device 132 outputting the content. The payment may be made in a manner and to an account in the device provider database 160 associated with the device provider or the device. The payment may be made in a manner and from an account associated with the customer in the customer account database 158. In another embodiment, the customer may enter a manner and an account for the payment to be made from on the user interface 112 of the mobile electronic device 102. The payment module 166 may include executable computer program code, and data stored on computer readable storage medium in the memory component 156, which when executed by the processor 154 may implement instructions of the methods shown and described in relation to FIGS. 5-6, and 8A-8C. Although illustrated as a single component, the lines or divisions of the executable computer program code need not be in consecutive order, and may not be located in the same section of code, or in the case of multiple processors, the same processor.

The system 100 may include a content server 174 which may store content 176 for outputting with the output device 132. The content server 174 may include any computer or operatively connected group of computers running a software application capable of storing and providing access to files to and from computer and electronic devices communicatively linked to the content server 174. The content server 174 may be, for example a cloud based file server providing accounts to customers who may then store and retrieve their files with computer and/or electronic devices communicatively linked to the content server 174. Content 176 stored on the content server 174 may be outputted by the output device 132 upon request by the mobile electronic device 102.

Communicative links 170 may be links which connect computer and/or electronic devices to networks 172. Communicative links 170 may include physical electrical, fiber optic, or other cables, cellular technology linking devices, internet linking devices such as DSL or regular phones lines, cable service lines, cell towers, satellite linking devices, satellites, and/or other communicative links. Networks 172 may include the Internet, cellular networks, satellite networks, and/or combinations of these and other similar communication networks which tie electronic and/or computer devices together.

Referring now to FIG. 2, an exemplary system 200 for a customer 202 to set-up a customer account on the pairing server 152 is illustrated. The system 200 may include an electronic device 210 communicatively connected to the pairing server 152 through communicative links 170 and/or network 172. The electronic device 210 may include a laptop computer 212, configured to allow the customer 202 to enter and transmit Account Information 204 to the pairing server 152. Other embodiments of the electronic device 210 may include a desktop computer, computer terminal, electronic tablet, smartphone, or the like. The laptop computer 212 may include a user interface 206 with user input devices such as, for example, a keyboard and mouse 208. The customer 202 may enter the account information 204 with the user interface 208. The account information 204 may be transmitted to the pairing server 152 and stored in the customer account database 158. The system 200 may be configured to implement the instructions shown and described in relation to FIG. 5.

Referring now to FIG. 3, an exemplary system 300 for a device provider 302 to set up a device provider account on the pairing server 152 and provide information on the output device 132 to the pairing server 152 is illustrated. The system 300 may include a device provider user interface 306 communicatively linked to the pairing server 152 through communicative links 170 and network 172; through which a device provider 302 may enter and transmit account information 304 to be stored in the device provider database 160, and device information 304 to be stored in the device information and driver database 162. The user interface 306 may, for example, comprise one or more input devices and displays of a user interface on a home computer 308, such as a keyboard, mouse, and monitor. In other embodiments, the user interface may include, but is not limited to input devices and display devices of a user interface on a smartphone, an electronic tablet, and/or a laptop computer.

The user interface 306 may be operably and communicatively connected to the output device 132 through a local connection 310, such that information from the controller 144 of the output device 132 may be transmitted to the pairing server 152 and stored in the device information and driver database 162. In some embodiments, some output device information 314, such as drivers for the output device 132, may be stored on an output device information server 312. The output device information server 312 may include any computer or operatively connected group of computers running a software application capable of storing and providing access to files to and from computer and electronic devices communicatively linked to the output device information server 312. In some embodiments, output device information 304, such as drivers, may already be stored in the device information and driver database 162.

In some embodiments, where the short range communications tag 140 is integral to the output device 132, the pairing server 152 may be configured to transmit information and commands through the user interface 306 to the output device 132, and in response to the transmitted information and commands, the output device 132 may write the identifying data on the short range communications tag 140. Other devices which are configured to write identifying data on the short range communications tag 140, may also be communicatively connected the pairing server 152. The system 300 may be configured to implement instructions shown and described in relation to FIG. 6.

Referring now to FIG. 4, an exemplary system 400 for the customer 202 to download the pairing application module 126 and register the mobile electronic device 102 with a customer account on the pairing server 152 is illustrated. The pairing module 126 may include a computer program product including a computer readable storage medium, and computer usable code stored on the computer readable storage medium, where, if executed by a processor, the computer readable code causes the electronic device 102 and/or a computer to execute instructions. The instructions may include receiving identifying data for the output device 132 from the NFC tag 142 associated with the output device 132, the identifying data received through the NFC reader/writer module 124; and receiving from the pairing server 152 functional and pricing information associated with the identifying data. Further the instructions may include displaying on the user interface 112 functional and pricing options to a user; and receiving a user input indicative of an output request, the output request including desired content output from the output device 132. Still further, the instructions may include sending the output request to the pairing server 152, the pairing server 152 configured to send the content data to the output device 132 in response to the output request.

In the embodiment illustrated in FIG. 4, the pairing module 126 may be downloaded onto the mobile electronic device 102 from an application provider server 402. The application provider server 402 may include any computer or group of computers running software which allows a user of the mobile electronic device 102, a home computer, or other device to select an application (app), stored on the application provider server 402, and download the app to the mobile electronic device 102, the home computer, or the other device. Non-limiting examples of application provider servers 402 include the computer or group of computers running the Google Play Store®, or the Apple Store®. In other embodiments, the pairing module 126 may be loaded onto the mobile electronic device 102 at the manufacturer, may be loaded from a DVD or other computer storage medium, or may be loaded onto the mobile electronic device 102 in any way known in the art to transfer computer software onto the mobile electronic device 102.

In the illustrated embodiment of the system 400, the mobile electronic device 102 is shown as a smartphone 104. The smartphone 104 includes the short range communication module 120 as a removable element. It is contemplated that short range communication modules 120 will soon be a standard feature on most mobile electronic devices 102. However, for older versions of the mobile electronic device 102, an add-on short range communication module 120 may be communicatively and removeably connected to the mobile electronic device 102.

The mobile electronic device 102 may be communicatively connected to the application provider server 402 through communication links 170 and network 172 such that the customer 202 (or other user) may select the pairing module 126 and upload it to the mobile electronic device. The mobile electronic device 102 may be communicatively connected to the pairing server 152 through communication links 170 and network 172 such that the customer 202 may associate the mobile electronic device 102 with their customer account in the customer account database 158. For example, the pairing module 126 may allow the IP address, MAC address, or other identifying feature of the mobile electronic device 102 to be associated with the customer account. Alternatively, the association may be stored in the pairing module 126 on the mobile electronic device 102, or parts of the association may be stored in the pairing module 126, and parts in the customer account database 158.

Referring now to FIG. 5 an exemplary method 500 for the customer 202 to set-up a customer account on the pairing server 152 is illustrated. The method 500 starts at step 502. A customer 202 wishing to establish an account on the system 100 to pair an electronic mobile device 102 with an output device 132, may enter account information 204 through the user interface 206. The user interface 206 may be an element of a mobile electronic device 210. In one embodiment, where the mobile electronic device 210 is configured with a browser which will support interactive websites (such as a laptop computer or desktop computer), the customer 202 may bring up a website which allows them to enter account information 204 through fillable screens. The account information 204 may then be stored by the pairing server 152. The customer 202 may enter account information 204 through typing, talking, or any other means known in the art. For example, in addition to a website with a visual interface, a website accessible to the visually impaired through audio and/or voice capabilities is contemplated. In another embodiment, the electronic device 210 may include a mobile device such as a smartphone with an application (app) for entering the information, or a mobile browser which can access a mobile website. Entry of information may be done through a touchscreen or other interface or a voice interface.

The customer 202 may enter customer identifying information through the user interface 206. The identifying information may include, but is not limited to, name, address, phone number, email address, user name, and password. In some embodiments, as an alternative to, or in addition to the user name and/or password, a fingerprint input, an eye scan input, or some other type of identity input may be entered (step 504). The identifying information may be transmitted to the pairing server 152, and stored in the customer account database 158 (step 506).

The customer 202 may enter payment information through the user interface 206. The payment information may include, but is not limited to, credit card information, bank account information, other payment account information, and preferred payment methods (step 508). The payment information may be transmitted to the pairing server 152, and stored in the customer account database 158 (step 510).

The customer 202 may enter mobile electronic device 102 information through the user interface 206. The mobile electronic device information may include, but is not limited to, information on mobile electronic devices 102 which the customer 202 desires to associate with the account. For example, if the customer 202 is entering the account information 204 from a smartphone 104 which the customer 202 desires to associate with their account, this information may be entered. The communication address and information related to the smartphone 104 or other mobile electronic device 102 may be determined (step 512). The mobile electronic device information may be transmitted to the pairing server 152, and stored in the customer account database 158 (step 514).

The customer 202 may enter content location and access information through the user interface 206. The content location and access information may include, but is not limited to, the identification and/or location of content servers 176 on which the customer 202 may have accounts and store content. Access information, such as user names and passwords may also be entered (step 516). The content location and access information may be transmitted to the pairing server 152, and stored in the customer account database 158 (step 518). The method 500 ends at step 520.

Referring now to FIG. 6 an exemplary method 600 for the device provider 302 to set up a device provider account on the pairing server 152 and provide information on the output device 102 to the pairing server 152 is illustrated. The method 600 starts at step 602. A device provider 302 may own or manage one or more output devices 132 which he/she would like to make available for output content to customers 202 with accounts on the pairing server 152, or customers 202 who may not have an account on the pairing server 152, but who have a mobile electronic device 102 with a pairing module 126. The device provider 302 may desire to establish an account on the system 100 to enable a customer 202 to pair their electronic mobile devices 102 with the device provider's 302 output device 132. The device provider 302 may enter account information 304 through the user interface 306. The user interface 306 may be an element of an electronic device, such as a desktop computer 308. In one embodiment, where the electronic device is configured with a browser which will support interactive websites (such as a laptop computer or desktop computer 308), the device provider 302 may bring up a website which allows them to enter account information 304 through fillable screens. The account information 304 may then be stored by the pairing server 152. The device provider 302 may enter account information 304 through typing, talking, or any other means known in the art. For example, in addition to a website with a visual interface, a website accessible to the visually impaired through audio and/or voice capabilities is contemplated. In another embodiment, the electronic may include a mobile device such as a smartphone with an application (app) for entering the information, or a mobile browser which can access a mobile website. Entry of information may be done through a touchscreen or other interface, or a voice interface.

The device provider 302 may enter device provider identifying information through the user interface 306. The identifying information may include, but is not limited to, business name, individual name, additional business contacts, business or individual tax ID, address, phone number, email address, user name, and password. In some embodiments, as an alternative to, or in addition to the user name and/or password, a fingerprint input, an eye scan input, or some other type of identity input may be entered (step 604). The identifying information may be transmitted to the pairing server 152, and stored in the device provider database 160 (step 606).

The device provider 302 may enter payment information through the user interface 306. The payment information may include, but is not limited to, account information on where payments for outputting content on the device provider's 302 output device(s) 132 may be deposited or sent (such as bank accounts, Paypal®, or other merchant accounts) and preferred payment methods (step 608). The payment information may be transmitted to the pairing server 152, and stored in the device provider database 160 (step 610).

The system 300 may determine whether the electronic device the device provider 302 is entering information through is connected to the one or more output devices 132, and which output devices 132 it is connected to, through a local connection. For example, the device provider 302 may be able to indicate in the interactive web browser that the output device 132 is connected, or the interface may detect automatically what devices are connected to the electronic device (step 612).

If the output device 132 is connected to the electronic device, the interface may automatically detect such information as the type of output device 132, the driver for the output device 132, communication information for the output device, and other information to allow the pairing server 152 to connect to and communicate with the output device 132. The device provider 302 may input additional information such as, but not limited to, the functions the output device 132 is capable of and/or available for. For example, if the output device 132 is a printer 134 information may be entered on size and type of paper available through which input, and whether color and/or black and white prints are available. In another example, if the output device is a large screen display 136, information on the size, definition, and hours of availability may be entered. Pricing information on each function may also be inputted by the device provider 302. The device information may be uploaded to the device information and driver database (step 614).

If the output device 132 is not connected to the user interface 306, the device provider 302 may enter information on the output device 132 (step 616). The pairing server 152 may also connect to and upload output device information 312 on the output device information server 314 (step 618), or associate the output device 132 with information already in the device information and driver database 162. Once communication information enabling the pairing server 152 to communicate with the output device 132 is obtained, the pairing server 152 may confirm that the communication information results in a communication link with the output device 132 (step 620). The method ends at step 622. After the device provider 302 has registered an output device successfully with the pairing server 152, the pairing server 152 may write identifying data to an integral short range communication tag 140, or read already existing identifying data. In another embodiment in which the short range communication tag 140 is not integral to the output device 132, a short range communication tag 140 with identifying data may be sent to the device provider 302 to associate with the output device 132. In still another embodiment, the device provider 302 may write the identifying data to the short range communication tag 140 through linking a device capable of writing to the short range communication tag 140 to the pairing server 152.

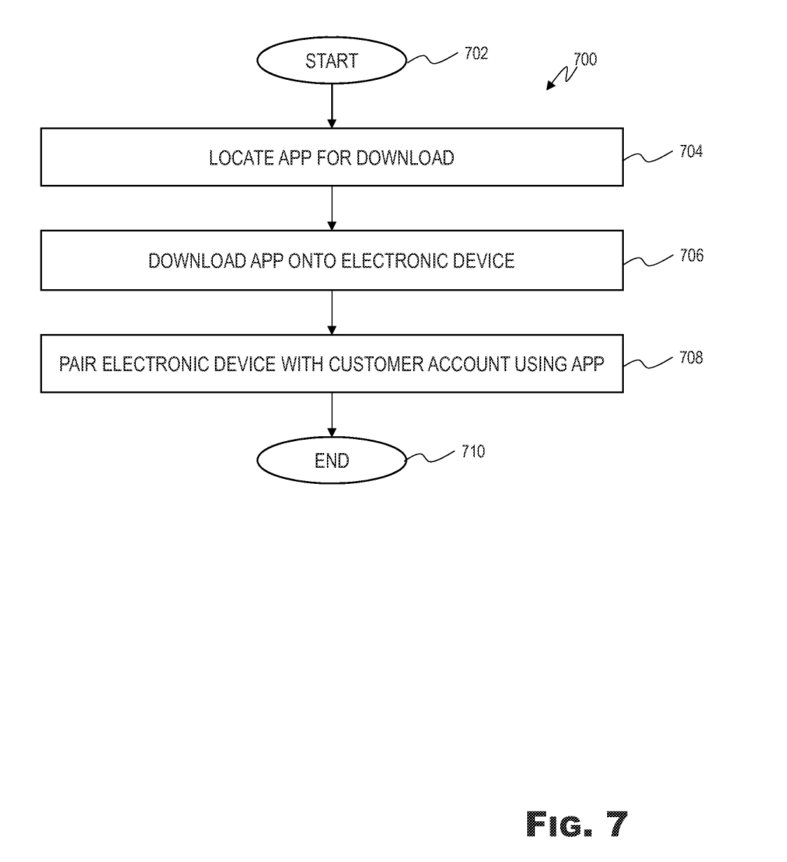

Referring now to FIG. 7, an exemplary method 700 for the customer 202 to download the pairing application module 126 and register the mobile electronic device 102 with a customer account on the pairing server 152 is illustrated. The customer 202 may desire to set-up a mobile electronic device 102 to communicate with the pairing server 152 in order to output content to the output device 132, and associate the mobile electronic device 102 with the customer's account on the system 100. In one embodiment, the customer 202 may desire to download the pairing module 126 from the application provider server 402 as an app. Other embodiments are contemplated in which the pairing module 126 is loaded on the mobile electronic device 102 at the manufacturer, or loaded in other ways known in the art. The method starts at 702.

The customer 202 may connect the mobile electronic device 102 to the network 172 through the communication link 170 and access an on-line store where apps are available for purchase and/or for free download. The customer 202 may locate the pairing module 126 app on the application provider server 402 (step 704). The customer 202 may download the app from the application provider server 402 as known in the art (step 708). Once the customer 202 has downloaded the pairing module 126 (or has pairing module installed on the mobile electronic device 102 through a different method), the customer 202 may desire to pair the mobile electronic device 102 with a customer account the customer 202 has created in the pairing server. The pairing module 126 may include code which when executed by the processor 116, allows the customer 202 to enter identifying information which is communicated to the pairing server 152. Once the customer's 202 account is found on the pairing server 152, the pairing module 126 on the mobile electronic device 102 and/or the customer account database 158 on the pairing server 152 will store information such that the mobile electronic device 102 is associated with the customer's 202 account (step 708). The method ends at 710.

Referring now to FIG. 8A, a first portion of an exemplary method 800 for pairing the mobile electronic device 102 with the output device 132 for outputting content is illustrated. The method 800 starts at step 802. A user of the mobile electronic device 102, may desire to output content to the output device 132 without the necessity of establishing a separate connection to the output device 132. For example, a user with a smartphone 104 may want to print a document at a public printer 134 which he/she created at a home computer and saved to a cloud storage service. In another example, a user with a laptop computer 108 may want to show a presentation on a large monitor in a meeting room. The user interface 112 may be used to open the pairing module 126 (step 804).

The pairing module 126 may display instructions to the user to hold the short range communication module 120 within the predetermined distance from the short range communication tag 140 of the output device 132 the user desires to output content on. The user may move the mobile electronic device 102 such that the short range communication module 120 is within the predetermined distance from the short range communication tag 140. The short range communication module 120 may provide power to the short range communication tag 140 and encrypted identifying information may communicated from the short range communication tag to the short range communication module 120. In another embodiment, pairing module 126 may be activated after the user brings the short range communication module 120 within the predetermined distance of the short range communication tag 140 and the identifying data is communicated. The mobile electronic device 102 may now be paired with the output device 132 (step 806).

The pairing module 126 may cause the mobile electronic device 102 to communicate the identifying data to the pairing server 152, and the pairing module 164 may identify the output device 132 from the device information and driver database 162 (step 808). The pairing module 164 may cause the pairing server 152 to request customer identification information from the mobile electronic device 102. The pairing module 126 may cause the mobile electronic device 102 to prompt the user through the user interface 112 to enter customer account information. The user may enter the customer account information through the user interface 112 or choose not to enter this information and proceed as a guest. In some embodiments, the mobile electronic device 102 may have stored customer account information and the customer may be prompted to confirm the information. The pairing module 126 may cause the mobile electronic device 102 to send the customer account information to the pairing server 152, and the pairing server 152 may identify the customer account in the customer account database (step 810).

The pairing module 126 may cause the mobile electronic device 102 to prompt the user through the user interface 112 to choose the desired content to be outputted by the output device 132. The content may be located on the memory component 118, or on the content server 176. In some embodiments, where the customer account includes association with a content source, the pairing server 152 may communicate the content source to the mobile electronic device 102, and the pairing module 126 may cause the mobile electronic device 102 to display this content source through the user interface as one choice of content source. Once the user has chosen the desired content, the user may be prompted on the user interface 112 to choose other options associated with the output device 132. For example, if the output device 132 is a printer 134, the user may be able to choose such options as color and paper size. The pairing server 152 may receive the user's content and option choices (step 812).

The pairing module 164 and/or the payment module 166 may determine the payment amount necessary for the content and output device 132 choices the user has made, and transmit these to the mobile electronic device 102 which may display the required payment through the user interface. The pairing module 126, 164 on the pairing server 152 and/or the mobile electronic device 102, and the payment module 166 may cause the user interface to prompt the user to enter payment information. If the user has entered customer account information, or the mobile electronic device has been associated with a customer account, the user interface may suggest payment information stored in the customer account database 158 and transmitted from the pairing server 152. Alternatively, the user may enter credit card or other type payment information. The payment information may be transmitted to the pairing server 152 (step 814).

The payment module 166 may check if the payment information is valid (step 816). If the payment information is not validated, the method 800 may proceed to step 836 which will be further described below in relation to FIG. 8B. If the payment information is validated, the pairing module 164 may check if the output device 132 is available, and if the output capability requested by the mobile electronic device 102 is functional (step 818). If the output device 132 is not functional, or does not have the capability to fulfill the content output request, the method 800 may proceed to step 840 which will be further described below in relation to FIG. 8C. If the output device 132 is functional, and capable of fulfilling the content output request, the method 800 may proceed to steps in FIG. 8B (step 820).

Referring now to FIG. 8B, a second portion of the exemplary method 800 of FIG. 8A for pairing the mobile electronic device 102 with the output device 132 for outputting content is illustrated. If the pairing module 164 confirms that the payment information is valid, the output device 132 is functional and capable to output the requested content, and that the content chosen by the user is available, the pairing server 152 may transmit a signal to the mobile electronic device 102. In response to the signal, the pairing module 126 may cause the user interface 112 to display a message to the customer/user that the pairing is successful, and request the customer/user make an input to the user interface 112 approving the sending of the content to the output device 102. The user interface 112 may confirm the content to be sent, the output device 132 it will be sent to, and the price for sending the content (step 822).

If the customer/user does not want the content to be outputted on the output device 132, the customer/user may make an input through the user interface 112 to indicate this. The method 800 then proceeds to the end at step 844 shown in FIG. 8C. If the customer/user makes an input through the user interface 112 approving the content to be sent to the output device 132, the method proceeds (step 824). The mobile electronic device 102 may send a signal to the pairing server 152 indicating the customer/user's approval of the output of the content to the output device 132. The pairing module 164 may obtain the content from the mobile electronic device 102, the location entered by the customer/user, or the location associated with the customer account. The content conversion module 159 may convert the data in the content file to a format which the output device 132 may read. The pairing module 164 may use the driver for the output device 132 in the device information and driver database to send the content to the output device in a manner that will cause the output device 132 to output the content. The pairing module 164 may also send to the output device other details of the content request. For example, if the output device 132 is the printer 134, the details may include the number of copies, the color of the copies, the size of the paper, and the time the output of content should occur. The output device 132 may then output the content (step 826).

The output device 132 may send a signal to the pairing server 152 indicating if the output of content was successful. If the output of the content was not successful, the method 800 may proceed to step 840 described below in relation to FIG. 8C. If the output of content was successful, the pairing server 152 may send a signal to the mobile electronic device 102 indicating the output of content was successful (step 828). The user interface 112 may display a message to the customer/user that the output of content was successful (step 830).

The payment module 166 may charge the customer/user according to the payment information entered, and/or payment information in the customer account database (step 832). The payment module 166 may pay the device provider through the information for payment in the device provider database 160 (step 834). The method 800 may then end at step 844 shown in FIG. 8C.

If the payment module 166 is unable to validate the payment information entered by the customer/user (see step 816), the pairing module 152 may send a signal to the mobile electronic device 102. In response to the signal, the user interface 112 may display a message to the customer/user indicating that the payment information could not be validated, and requesting the customer/user re-enter the payment information, enter new payment information, or cancel the content output request (step 836). The method 800 continues to FIG. 8C.

Referring now to FIG. 8C, a third portion of the exemplary method 800 of FIGS. 8A and 8B for pairing the mobile electronic device 102 with the output device 132 for outputting content is illustrated. If the customer/user cancels the content output request, the method 800 ends at step 844. If the customer/user re-enters the payment information, or enters new payment information, the method returns to step 814 (step 838).

If the pairing server 152 determines that the output device 132 is not functioning and/or does not have the capability to output the content as requested by the customer/user, (see step 820), the pairing server 152 may check the device information and driver database 162 for any output devices 132 near the one previously chosen, and capable of fulfilling the content request. The pairing module 152 may send a signal to the mobile electronic device 102. In response to the signal, the user interface 112 may display a message to the customer/user indicating that the output device 132 is either not functioning, not capable of fulfilling the content request, or both, and requesting the customer/user choose and pair with another output device 132, or cancel the content output request. The user interface 112 may display the locations of other output devices 132 near the output device 132 previously chosen which are capable of fulfilling the content request (step 840). If the customer/user goes to the location of the short range communication tag 140 associated with an alternative output device 132, the method may return to step 806. If the customer/user cancels the content request, the method proceeds to the end at step 844 (step 842).

It should be understood, of course, that the foregoing relates to exemplary embodiments of the invention and that modifications may be made without departing from the spirit and scope of the invention as set forth in the following claims.

I claim:

1. A system to pair a mobile electronic device to an output device to output content from content data stored on a memory component, the memory component located in the mobile electronic device or locatable by the mobile electronic device; comprising:
a pairing server comprising;
an output device information and driver database including communication, driver, and identifying data associated with the output device; and
a pairing module configured to send the content data to the output device in response to an output request by the mobile electronic device, and to send the content data to the output device utilizing the communication, driver, and identifying data associated with the output device;
the output device including a output device communication module configured to send and receive data to and from the pairing server;
a short range communication tag associated with the output device, and comprising the identifying data associated with the output device;
a short range communication module communicatively and removeably coupled to, or comprising an element of, the mobile electronic device;
and configured to receive the identifying data from the short range communication tag; and
the mobile electronic device comprising;
a communication module configured to send and receive data to and from the pairing server; and
a pairing application module, the pairing module configured to send an output request to the pairing server, the output request including the identifying data, and at least one of the content data or a location of the content data.

2. The system to pair a mobile electronic device to an output device of claim 1, wherein the short-range communication module is a near field communication reader/writer module; and the short-range communication tag is a near field communication tag.

3. The system to pair a mobile electronic device to an output device of claim 1, wherein the output device comprises at least one of a 2D paper printer, a large screen display, and a 3D printer.

4. The system to pair a mobile electronic device to an output device of claim 1, wherein the mobile electronic device includes a content creator module, and the content data is created by the content creator module and stored on a memory component which is an element of the mobile electronic device.

5. The system to pair a mobile electronic device to an output device of claim 1, wherein the mobile electronic device comprises at least one of a smart phone, an electronic tablet, and a laptop computer.

6. The system to pair a mobile electronic device to an output device of claim 1, wherein the mobile electronic device further comprises a user interface configured to allow a user to input a desired content data request.

7. The system to pair a mobile electronic device to an output device of claim 1, wherein the short range communication tag is an integral element of the output device.

8. The system to pair a mobile electronic device to an output device of claim 1, wherein the short range communication tag is not integral to the output device.

9. The system to pair a mobile electronic device to an output device of claim 1, wherein the pairing server includes a device provider database containing pricing data on the output device, and the pairing server is configured to send the pricing data to the mobile electronic device in response to an output request from the mobile electronic device.

10. The system to pair a mobile electronic device to an output device of claim 1, wherein the pairing server includes a customer account database including customer payment data, and a payment module configured to make a payment in response to the output device outputting content at least in part based on the customer payment data.

11. A computer program product comprising:
a computer readable storage medium, and
computer usable code stored on the computer readable storage medium, where, if executed by a processor, the computer readable code causes a computer to:
receive identifying data for an output device from a near field communication tag associated with the output device, the identifying data received through a near field communication reader/writer module;
receive from a pairing server functional and pricing information associated with the identifying data;
display on a user interface functional and pricing options to a user;
receive a user input indicative of an output request, the output request including desired content output from the output device; and
send the output request to the pairing server, the pairing server configured to send the content data to the output device in response to the output request.

12. The computer program product of claim 11, wherein the computer readable code further causes the computer to query the user on an acceptability of pricing for the output request, and receive a user input indicating the acceptability or unacceptability of the pricing for the output request.

13. The computer program product of claim 11, wherein the computer readable code further causes the computer to display on a user interface at least one content output stored on a memory device of the computer; and wherein the user input indicative of the output request, includes desired content output stored on the memory device of the computer.

14. A method of pairing a mobile electronic device with an output device through a pairing server, comprising:
wirelessly transmitting encrypted identifying data associated with the output device from a short range communication tag to the mobile electronic device through a short range communication link;
transmitting through at least one of a communication link and a network, a content output request from the mobile electronic device to the pairing server, the content output request indicative of the identifying data and desired content to be outputted by the output device;
transmitting through at least one of communication links and a network, the desired content from the pairing server to the output device; and
outputting the desired content with the output device.

15. The method of claim 14, further comprising converting the desired content from a first form of data to a second form of data with the pairing server and transmitting the second form of data to the output device.

16. The method of claim 14, further comprising transmitting through at least one of a communication link and a network, payment information from the mobile electronic device to the pairing server, and making a payment to a device provider associated with the output device as a function of, at least in part, to the payment information.

17. The method of claim 14, wherein the short range communication link comprises a near field communication link, and the short range communication link is activated when the mobile electronic device is within a predetermined distance from the short range communication tag.

18. The method of claim 17, wherein the predetermined distance comprises a distance in a range from eight centimeter to twelve centimeters.

19. The method of claim 14, wherein the desired content is located on a content server, and further comprising transmitting through at least one of a communication link and a network, the desired content from the content server to the pairing server.

20. The method of claim 14, wherein the mobile electronic device includes a content creation module; and further comprising creating the desired content with the content creation module.
